(19) United States
(12) Patent Application Publication
(10) Pub. No.: US 2024/0071658 A1
(43) Pub. Date: Feb. 29, 2024

(54) Cerium-Added RE-T-B-M Series Sintered Neodymium-Iron-Boron Magnet

(71) Applicant: Yantai Dongxing Magnetic Materials Inc., Yantai (CN)

(72) Inventors: Xiulei CHEN, Yantai (CN); Zhongjie PENG, Yantai (CN); Zhanji DONG, Yantai (CN); Kaihong DING, Yantai (CN); Xiandong XU, Yantai (CN)

(21) Appl. No.: 18/239,751

(22) Filed: Aug. 29, 2023

(30) Foreign Application Priority Data
Aug. 30, 2022 (CN) 202211047034.7

(51) Int. Cl. H01F 1/057; B22F 1/142; B22F 3/16; B22F 3/24; B22F 9/02; B22F 9/04; B22F 9/08; C22C 38/00; C22C 38/06; C22C 38/10; C22C 38/14; C22C 38/16

(52) U.S. Cl. CPC H01F 1/0577; B22F 1/142; B22F 3/16; B22F 3/24; B22F 9/023; B22F 9/04; B22F 9/08; C22C 38/002; C22C 38/005; C22C 38/06; C22C 38/10; C22C 38/14; C22C 38/16; B22F 2003/248; B22F 2009/044; B22F 2201/20; B22F 2202/05; B22F 2301/355; B22F 2998/10; B22F 2999/00; C22C 2202/02

(57) ABSTRACT

The present disclosure discloses a cerium-added RE-T-B-M series sintered neodymium-iron-boron magnet, which relates to the technical field of neodymium-iron-boron permanent magnets, the structure of the magnet contains a RE₂Fe₁₄B main phase, a RE-rich phase, a REFe₂ phase, and a sandwich grain boundary phase, wherein the sandwich grain boundary phase includes a RE-rich phase, a Fe-rich phase, and a REFe₂ phase, and in the sandwich grain boundary phase, starting from the side near the grains of RE₂Fe₁₄B main phase, the first layer is the RE-rich phase, the second layer is the Fe-rich phase, and the third layer is the REFe₂ phase, where RE includes cerium element and at least one of other rare earth elements, and the cerium element accounts for 3.0-15.0% by mass of the total elements, T is iron element and cobalt element, B is boron element, and M is Al, Cu, Ga, and Ti elements. A cerium-added RE-T-B-M series sintered neodymium-iron-boron magnet according to the present disclosure can alleviate the negative effects on the magnet due to the addition of cerium element.

### TECHNICAL FIELD

The present disclosure relates to the technical field of neodymium-iron-boron permanent magnets, in particular to a cerium-added RE-T-B-M series sintered neodymium-iron-boron magnet.

### BACKGROUND

High abundance light rare earth elements, such as lanthanum and cerium, etc. have a very low price and are increasingly being added to neodymium-iron-boron magnets. However, rare earth elements such as lanthanum and cerium, etc. have low magnetic property parameters, the addition of which will lead to a significant decrease in the magnetic properties of rare earth magnetic materials. In order to reduce the impact of the addition of elements such as lanthanum and cerium, etc. on the magnetic properties of rare earth magnetic materials, multiple main phase processes and surface grain boundary diffusion processes have been widely applied. The Chinese patent with Authorized Announcement No. CN102800454B discloses a low-cost double-main phase Ce permanent-magnet alloy and preparation method thereof, which obtains high magnetic properties by forming two different HA main phases of a Nd—Fe—B phase and a (Ce, Re)—Fe—B phase. However, the HA of the (Ce, RE)—Fe—B main phase in this method is reduced too much, which limits the improvement of magnetic properties. The patent for disclosure with Publication Number WO2020233316A1 discloses a cerium magnet with diffused grain boundaries containing REFe₂ phase and a preparation method therefor. The patent utilizes rare earth elements to diffuse into a matrix containing CeFe₂ phase, strengthening the CeFe₂ phase, and the strengthened phase is transformed into REFe₂ phase, improving the coercivity thereof. However, no matter what method is used, when the amount of cerium added is high, it is easy to generate REFe₂ phase in the grain boundary phase. The magnetic isolation effect of the pure REFe₂ phase is weak, the ability to suppress reverse domain movement in the demagnetizing field is poor, and the coercivity of the magnet is low.

Cerium as a low-cost rare earth raw material, the addition of it can significantly reduce costs. However, due to the low magnetic parameters of Ce₂Fe₁₄B, when the amount of cerium added is high, the proportion of low magnetic parameters of Ce₂Fe₁₄B in the main phase is relatively large, resulting in a decrease in comprehensive magnetic properties. At the same time, the addition of cerium will also form a REFe₂ phase with relatively weak magnetic isolation effect in the grain boundary phase, the REFe₂ phase is distributed among the main phase grains, under the demagnetizing field conditions, the reverse magnetic domain is relatively easy to transfer among the main phase grains, and the macroscopic manifestation is a decrease in coercivity.

### SUMMARY

The object of the present disclosure is to overcome the shortcomings in the existing technology and reduce the negative effects on the magnetic properties of rare earth magnetic materials due to the addition of cerium. To this end, the present disclosure provides a cerium-added RE-T-B-M series sintered neodymium-iron-boron magnet.

Technical solution: in order o achieve the above object, the present disclosure provides a cerium-added RE-T-B-M series sintered neodymium-iron-boron magnet, the structure of the magnet comprises a sandwich grain boundary phase, and the sandwich grain boundary phase comprises a RE-rich phase, a Fe-rich phase, and a REFe₂ phase, wherein in the sandwich grain boundary phase, starting from the side near the grains of RE₂Fe₁₄B main phase, the first layer is the RE-rich phase, the second layer is the Fe-rich phase, and the third layer is the REFe₂ phase, where RE comprises cerium element and at least one of other rare earth elements, and the cerium element accounts for 3.0-15.0% by mass of the total elements, T is iron element and cobalt element, B is boron element, and M is Al, Cu, Ga, and Ti elements.

It is crucial for the content of cerium element to be within the range specified above, which can ensure its beneficial effects, and during the preparation of sample alloys according to the cerium element addition amount specified above, cerium is prone to precipitation from the main phase, forming the REFe₂ phase. There are RE₂Fe₁₄B main phase, REFe₂ phase, and RE-rich phase, etc. in the magnet. The RE-rich phase has good wettability for the main phase grains, and when heat treatment is carried out near the eutectic point of the RE-rich phase, the RE-rich phase in the grain boundaries is enriched in the periphery of the main phase grains, forming the first layer of grain boundary layer. The rare earth elements in the REFe₂ phase adjacent to the first layer of grain boundary layer can precipitate out and diffuse into the RE-rich phase when heat treatment is carried out near the eutectic point of the rare earth elements, resulting in a higher content of rare earth elements in the original RE-rich phase. At the same time, the REFe₂ phase after the precipitation of rare earth elements transforms into a Fe-rich phase, forming the second layer of grain boundary layer. REFe₂, which is far from the main phase grains, maintains its original state and forms a third layer of grain boundary layer. The three phases form a sandwich-like sandwich structure. Samples with low content of cerium have a lower concentration of cerium in the main phase, making it difficult to precipitate and form the REFe₂ phase during heat treatment, while samples with too high content of cerium have relatively high content of cerium in the grain boundary phase, forming a large number of REFe₂ phases in the grain boundary phase, with a wide distribution range, and there is no space for the formation of RE-rich phase with high rare earth content, thus the sandwich grain boundary structure cannot be formed.

Further, in the RE-rich phase of the sandwich grain boundary phase, the element RE atoms account for 50.2% to 62.3%, element T atoms account for 32.2% to 39.7%, and element M atoms account for 2.2% to 10.1%.

Further, in the Fe-rich phase of the sandwich grain boundary phase, the element RE atoms account for 12.4% to 26.0%, element T atoms account for 68.1% to 81.4%, and element M atoms account for 1.3% to 6.2%.

Further, in the REFe₂ phase of the sandwich grain boundary phase, the element RE atoms account for 28.1% to 33.8%, element T atoms account for 61.4% to 69.8%, and element M atoms account for 0.6% to 4.8%.

Further, in the sandwich grain boundary phase, the thickness of the RE-rich phase is 1 nm to 21 nm, the thickness of the Fe-rich phase is 1 nm to 15 nm, and the thickness of the REFe₂ phase is 8 nm to 550 nm.

Further, the structure of the magnet also comprises a RE₂Fe₁₄B main phase, a RE-rich phase, and a REFe₂ phase, the structure of the magnet comprises RE, boron, aluminum, cobalt, copper, gallium, titanium, iron elements and impurities, the content of each element relative to the total mass is respectively as follows: 30.10 wt. % to 33.50 wt. % of RE element, 0.85 wt. % to 1.05 wt. % of boron element, 0.05 wt. % to 0.60 wt. % of aluminum element, 0.50 wt. % to 2.00 wt. % of cobalt element, 0.10 wt. % to 0.50 wt. % of copper element, 0.10 wt. % to 0.50 wt. % of gallium element, 0.10 wt. % to 0.40 wt. % of titanium element, with the balance of iron element and impurities.

A cerium-added RE-T-B-M series sintered neodymium-iron-boron magnet of the present disclosure has at least the following technical effects: in the sandwich grain boundary structure, and in the RE-rich phase in contact with the outside of the main phase grain in the first layer of grain boundary layer, the rare earth content exceeds 50 at. %, and the Fe content is lower than 50 at. %. Such grain boundary phase with an high rare earth content has poor magnetic conductivity and better magnetic isolation effect, effectively suppressing the movement of magnetic domains during demagnetization. In addition, there are grain boundary phases with high rare earth content in the periphery of the main phase grains, which reduces the defects in the periphery of the main phase grains and makes it difficult for reverse domains to form nuclei. Although the Fe-rich phase in the second layer of grain boundary layer on the outer side of the RE-rich phase has a relatively high iron content and thus a certain magnetic conductive ability, when the reverse magnetic domain is transferred through the sandwich structure, the transfer ability of which becomes weaker after being isolated by the RE-rich phase in the first layer. Although the magnetic isolation effect of REFe₂ phase in the third layer is not as strong as that of RE phase in the first layer, it can also prevent the transfer of reverse magnetic domains to adjacent main phase grains due to its large thickness. Through the effective magnetic isolation effect of the sandwich structure, the main phase grains are magnetically isolated, improving the coercivity.

### BRIEF DESCRIPTION OF THE DRAWINGS

FIG. 1 shows a schematic diagram of the microstructure of the magnet with a sandwich grain boundary phase and a schematic diagram of the testing methods for each grain boundary layer according to the present disclosure; and

FIG. 2 shows the HAADF-STEM and EDS images of the grain boundary position of the magnet in Example 1.

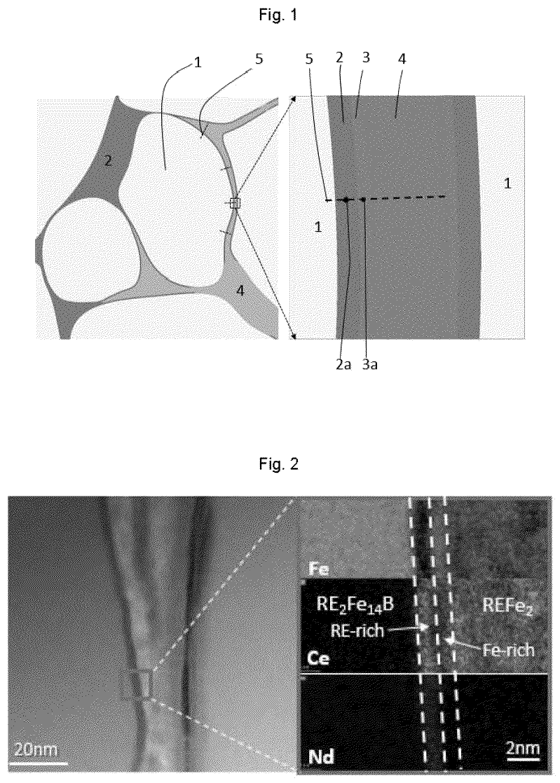

In FIG. 1, 1: main phase; 2: RE-rich grain boundary phase; 2a: center point of RE-rich grain boundary phase; 3: Fe-rich grain boundary phase; 3a: center point of Fe-rich grain boundary phase; 4: REFe₂ grain boundary phase; 5: position for testing the thickness of sandwich grain boundary phase.

### DETAILED DESCRIPTION OF THE EMBODIMENTS

The principles and features of the present disclosure will be described below in conjunction with FIG. 1 to FIG. 2. The listed examples are only intended to explain the present disclosure, rather than limiting the scope thereto.

There is provided a method of preparing the cerium-added RE-T-B-M series sintered neodymium-iron-boron magnet, including the following steps:

Alloy flakes were prepared by strip-casting process by vacuum induction furnace. The strip casting alloys were subjected to hydrogen decrepitation and airflow grinding and crushing process to be pulverized into magnetic powders.

The magnetic powders were then pressed molding into green billets under a magnetic field for orientation. The green billets should also be subjected to cold isostatic pressing for density increasing and homogeneous. Then, take a sintering process to the green billets. Temperature interval of sintering step was preferably set as 1000-1050° C. with a duration time of 4-12 hours. More preferably, in the present method, sintering temperature was set as 1010° C. for a duration time of 6 hours.

After sintering, the magnets were subjected to 3 steps of annealing treatment. Preferably, the first step annealing temperature was between 630-730° C. which near the eutectic point of RE-rich phase. RE-rich phase had better wettability and easy to coat around the main phase grains to form the first grain boundary layer. The second step annealing temperature was between 820-930° C. which near the eutectic point of REFe₂ phase. Rare earth element can separate out from REFe₂ phase and diffuse into the RE-rich of the first grain boundary layer, the RE-rich phase then had a higher rare earth element concentration. The REFe₂ phase transformed into Fe-rich phase because of the reduction of rare earth element concentration. This kind of Fe-rich phase formed the second grain boundary layer. The residual part of REFe₂ phase which far away from the main phase grains maintained the original state and formed the third grain boundary layer. Afterwards, the third step annealing temperature was in the range of 450-540° C. for optimizing the grain boundary distribution. More preferably, in the implementing examples, the first step annealing temperature was set as 650° C. and the cooling rate was at least 10° C./min. The second step annealing temperature was set as 850° C. and the cooling rate was at least 10° C./min. The third step annealing temperature was set as 480° C. and the cooling rate was at least 10° C./min.

A preparation method of a cerium-added RE-T-B-M series sintered neodymium-iron-boron magnet, including the following steps:
(S1) preparation of alloy flakes: mixing the elements according to the addition amount, and then preparing the raw material into an alloy melt spinning flake by use of the strip-casting process, so that the alloy had a uniform distribution of components.
(S2) crushing process: crushing the prepared alloy melt spinning flake, wherein in this example, the crushing process adopted two steps of dehydrogenation process and airflow grinding and crushing, specifically including absorbing hydrogen by subjecting the alloy plate to a hydrogen pressure of 0.2 Mpa for 2 hours, followed by dehydrogenating at 550° C. for 6 hours. After the hydrogen treatment, the alloy plate was ground into magnetic powders with an average particle size of 4.0 μm by airflow.
(S3) molding and orientating processes: loading the magnetic powder into a mold, applying a magnetic field with an intensity of 2.0 T, and press molding to make the magnetic powder have a suitable density and orientate along the easy axis of magnetization.
(S4) Cold isostatic pressing process: placing the green billets pressed by the press into a liquid such as water or oil, etc., applying a pressure of 200 Mpa to make the force evenly distributed on the green billets in all directions, so that the porosity inside the green billets was reduced, and the green billets were further densified and homogenized.
(S5) sintering process: sintering was a densification process of the green billets under vacuum or inert gas protection conditions. During the sintering process, appropriate heating rates and holding periods, etc. were set to promote the removal of adsorbed gases, water vapor, and organic matters in the magnetic powder, to eliminate stress, to reduce porosity, and at the same time, the grains grew and the blanks were densified. The suitable sintering temperature range was 1000° C. to 1050° C., and the sintering time was 4 hours to 12 hours. Excessive sintering temperature can improve the wettability of the main phase grains and REFe₂ phase, making it difficult for the RE-rich phase to diffuse to the periphery of the main phase and form the first layer of grain boundary layer. On this basis, in this example, the sintering temperature was set at 1010° C. and the sintering time was set to be 6 hours.
(S6) Ageing process: annealing the blanks after they were sintered to promote the generation and uniform distribution of grain boundary phases, and to improve the coercivity of the magnet. The aging conditions were related to the components of the magnet, and the like, and a reasonable aging process can obtain continuous and clear effective grain boundary phases, which will play an important role in improving the coercivity of the magnet. During the first stage aging treatment, the temperature was suitably set at 630° C. to 730° C., which was near the eutectic point temperature of the RE-rich phase, within this temperature range, the heat treatment can cause the RE-rich phase to diffuse towards the periphery of the main phase grains, and due to the better wettability of the RE-rich phase compared to the main phase, it was easy to coat on the main phase grains to form the first layer of grain boundary phase, and during the secondary aging treatment, the temperature was suitably set at 820° C. to 930° C., which was near the eutectic point temperature of the REFe₂ phase, during the heat treatment process, the precipitation of rare earth elements in the REFe₂ phase occurred, and the precipitated rare earth elements diffused into the RE-rich phase on the surface of the main phase grains, the REFe₂ phase out of which the rare earth elements precipitated became the Fe-rich phase, forming a second layer of grain boundary phase, and resulting in a higher content of rare earth elements in the RE-rich phase. The REFe₂ phase, which was far from the main phase, maintained its original form and served as the third layer of grain boundary phase, and during the third stage aging treatment, the temperature was suitably set at 450° C. to 540° C. to optimize the distribution of grain boundaries. In the implementation, the first stage aging temperature in the example was set at 650° C., and the cooling rate was greater than or equal to 10° C./min during the process of cooling to room temperature; the second stage aging temperature in the example was set at 850° C., and the cooling rate was greater than or equal to 10° C./min during the process of cooling to room temperature; and the third stage aging temperature in the example was set at 480° C., and the cooling rate was greater than or equal to 10° C./min during the process of cooling to room temperature. During the cooling process of aging at all stages, increasing the cooling rate was conducing to maintaining the generated structure of grain boundaries.

By controlling the proportion of Ce element, the first stage aging temperature was set near the eutectic point of the RE-rich phase, promoting its diffusion towards the periphery of the main phase grains. The second stage aging temperature was set near the eutectic point of the REFe₂ phase, which was conducive to the diffusion of rare earth atoms in the REFe₂ phase towards the RE-rich phase, forming a new RE-rich phase with high rare earth content, which had better magnetic isolation effect. The REFe₂ phase out of which RE was precipitated was transformed into Fe-rich phase. The REFe₂ phase was distributed in the outer layer of the Fe-rich phase, with the content of Fe therein being higher than RE-rich phase but lower than Fe-rich phase, and the thickness thereof being relatively large. It can also weaken the transfer of magnetization reversal domains to some extent.

The magnets prepared through steps (S1) to (S6) were processed into cylinders with a diameter of 10 mm and a height of 10 mm for magnetic property testing.

### EXAMPLES

Alloy flakes were separately prepared by strip casting process by vacuum induction furnace according to composition of implementing examples 1-4 and comparative examples 1-2. The alloys were subjected to hydrogen decrepitation under a hydrogen of 0.2 Mpa for a duration time of 2 hours. And then the alloys were heated to 550° C. for dehydrogenation for a duration time of 6 hours.

The alloy flakes after hydrogen treatment were then pulverized to magnetic powders with average particle size of 4.0 μm by jet milling. Then the magnetic powders were pressed into green compact under a 2.0 T magnetic field for orientation. The green compacts were subjected to cold isostatic pressing under a pressure of 200 Mpa. The green compacts were sintered at 1010° C. for a duration time of 6 hours in a vacuum furnace. After cooling to room temperature the sintered magnet were reheated to 650° C. for a duration time of 3 hours and then cooled to room temperature with a cooling rate at least 10° C./min. Then the magnets were reheated to 850° C. for a duration time of 3 hours, after which the magnets were cooled to room temperature with a cooling rate at least 10° C./min. At last the magnets were reheated to 480° C. for a duration time of 3 hours and then cooled to room temperature with a cooling rate at least 10° C./min.

Subsequently, the microstructure of the magnet was analyzed by use of transmission electron microscopy (TEM) and X-ray energy dispersive spectroscopy (EDS), the specific testing method was as follows: one sample was taken from examples 1 to 4, respectively, and five main phase grains were selected from each sample, wherein the longest grain boundary phase having a sandwich structure on the periphery of each main phase grain was divided into four lines in equal parts based on its length, the longest grain boundary was divided into five equal parts and made vertical lines perpendicular to the grain boundary phase, the thickness of each grain boundary layer in the sandwich structure corresponding to the four lines in equal parts was measured. 20 sets of data about the thickness of the sandwich grain boundary phase were obtained for each sample. The maximum, minimum, and average values were calculated. The method for testing the components of grain boundary phases having a sandwich structure involved selecting the center points of each grain boundary phase on the above lines in equal parts, and using X-ray energy dispersive spectroscopy (EDS) for element content analysis, and 20 sets of data about the components of each sample were obtained, and the average values were taken.

The testing results are as shown in Table 1. Components and magnetic properties of samples in examples and comparative examples were showed in table 1. The information about thickness of each grain boundary phase in the sandwich grain boundary structure was summarized in Table 2. The element contents in the RE-rich phase of the sandwich grain boundary structure were summarized in Table 3, the element contents in the Fe-rich phase of the sandwich grain boundary structure were summarized in Table 4, and the element contents in the REFe₂ phase of the sandwich grain boundary structure are summarized in Table 5.

TABLE 1
Components and magnetic properties of samples in examples and comparative examples

| | Contents of elements (wt. %) | | | | | | | | | | Magnetic properties | |
|---|---|---|---|---|---|---|---|---|---|---|---|---|
| | Al | B | Co | Cu | Fe | Ga | Nd/Pr | Ti | Ce | ΣRe | Br(T) | Hcj(kA/m) |
| Example 1 | 0.05 | 0.92 | 0.90 | 0.15 | Balance | 0.20 | 24.30 | 0.15 | 6.00 | 30.30 | 1.38 | 995.80 |
| Example 2 | 0.60 | 1.05 | 0.50 | 0.10 | Balance | 0.10 | 27.10 | 0.40 | 3.00 | 30.10 | 1.39 | 1313.40 |
| Example 3 | 0.10 | 0.85 | 2.00 | 0.50 | Balance | 0.50 | 26.50 | 0.10 | 7.00 | 33.50 | 1.29 | 1277.58 |
| Example 4 | 0.05 | 0.92 | 0.9 | 0.15 | Balance | 0.2 | 15.30 | 0.15 | 15.00 | 30.30 | 1.31 | 827.84 |
| Comparative | 0.05 | 0.92 | 0.90 | 0.15 | Balance | 0.20 | 28.30 | 0.15 | 2.00 | 30.30 | 1.41 | 1086.54 |
| example 1 | | | | | | | | | | | | |
| Comparative | 0.05 | 0.92 | 0.90 | 0.15 | Balance | 0.20 | 12.30 | 0.15 | 18.00 | 30.30 | 1.27 | 644.76 |
| example 2 | | | | | | | | | | | | |

TABLE 2
Thickness of each grain boundary phase in the sandwich grain boundary structure

| | RE-rich phase in sandwich | | | Fe-rich phase in sandwich grain | | | REFe₂ phase in sandwich grain | | |
|---|---|---|---|---|---|---|---|---|---|
| | grain boundary structure | | | boundary structure | | | boundary structure | | |
| | Maximum | Minimum | Average | Maximum | Minimum | Average | Maximum | Minimum | Average |
| | thickness | thickness | thickness | thickness | thickness | thickness | thickness | thickness | thickness |
| | (nm) | (nm) | (nm) | (nm) | (nm) | (nm) | (nm) | (nm) | (nm) |
| Example 1 | 8 | 1 | 4 | 7 | 2 | 3 | 471 | 9 | 47 |
| Example 2 | 7 | 1 | 3 | 6 | 1 | 3 | 436 | 8 | 41 |
| Example 3 | 21 | 2 | 8 | 15 | 2 | 7 | 550 | 12 | 58 |
| Example 4 | 19 | 1 | 7 | 9 | 2 | 6 | 535 | 11 | 53 |

| | |
|---|---|
| Comparative | No sandwich grain boundary structure |
| example 1 | |
| Comparative | No sandwich grain boundary structure |
| example 2 | |

TABLE 3
Element contents in the RE-rich phase of the sandwich grain boundary structure
RE-rich phase in sandwich grain boundary structure

| | RE | Fe + Co | Al | Cu | Ga | Ti | M(Al + Cu + Ga + Ti) |
|---|---|---|---|---|---|---|---|
| | (at. %) | (at. %) | (at. %) | (at. %) | (at. %) | (at. %) | (at. %) |
| Example 1 | 54.9 | 42.9 | 0.4 | 0.8 | 0.5 | 0.5 | 2.2 |
| Example 2 | 50.2 | 39.7 | 3.8 | 1.7 | 1.5 | 3.1 | 10.1 |
| Example 3 | 62.3 | 32.2 | 1.8 | 0.8 | 1.4 | 1.5 | 5.5 |
| Example 4 | 56.3 | 41.4 | 0.3 | 0.7 | 0.6 | 0.7 | 2.3 |

| | |
|---|---|
| Comparative | No sandwich grain boundary structure |
| example 1 | |
| Comparative | No sandwich grain boundary structure |
| example 2 | |

TABLE 4
Element contents in the Fe-rich phase of the sandwich grain boundary structure
Fe-rich phase in sandwich grain boundary structure

| | RE | Fe + Co | Al | Cu | Ga | Ti | M(Al + Cu + Ga + Ti) |
|---|---|---|---|---|---|---|---|
| | (at. %) | (at. %) | (at. %) | (at. %) | (at. %) | (at. %) | (at. %) |
| Example 1 | 19.2 | 79.5 | 0.3 | 0.3 | 0.3 | 0.4 | 1.3 |
| Example 2 | 12.4 | 81.4 | 3.3 | 0.8 | 0.9 | 1.2 | 6.2 |
| Example 3 | 26.0 | 68.1 | 1.2 | 2.1 | 1.4 | 1.2 | 5.9 |
| Example 4 | 22.3 | 75.4 | 0.6 | 0.7 | 0.5 | 0.5 | 2.3 |

| | |
|---|---|
| Comparative | No sandwich grain boundary structure |
| example 1 | |
| Comparative | No sandwich grain boundary structure |
| example 2 | |

TABLE 5
Element contents in the REFe₂ of the sandwich grain boundary structure
REFe₂ phase in sandwich grain boundary structure

| | RE | Fe + Co | Al | Cu | Ga | Ti | M(Al + Cu + Ga + Ti) |
|---|---|---|---|---|---|---|---|
| | (at. %) | (at. %) | (at. %) | (at. %) | (at. %) | (at. %) | (at. %) |
| Example 1 | 30.1 | 69.3 | 0.2 | 0.2 | 0.1 | 0.1 | 0.6 |
| Example 2 | 28.1 | 69.8 | 1.1 | 0.2 | 0.4 | 0.4 | 2.1 |
| Example 3 | 33.8 | 61.4 | 0.8 | 1.7 | 1.4 | 0.9 | 4.8 |
| Example 4 | 28.5 | 68.1 | 0.6 | 0.8 | 1.0 | 1.0 | 3.4 |

| | |
|---|---|
| Comparative | No sandwich grain boundary structure |
| example 1 | |
| Comparative | No sandwich grain boundary structure |
| example 2 | |

In Example 1, the addition amount of Ce was 6.0% by mass, with a remanence reaching 1.38 T and a coercivity reaching 995.80 kA/m. In Example 4, although the addition amount of Ce was up to 15.0% by mass, its coercivity can still reach 827.84 kA/m. Combined with the analysis of microstructure, it can be seen that sandwich grain boundary structures composed of RE-rich phase, Fe-rich phase, and REFe₂ phase were formed in samples of Examples 1 to 4. The existence of such structure can suppress the reduction of coercivity in the case of high addition amount of Ce. In sample having an addition amount of 2.0% by mass of Ce in comparative example 1, the concentration of Ce was relatively low, and no REFe₂ phase and sandwich grain boundary structure was detected. In sample having an addition amount of 18.0% by mass of Ce in comparative example 2, a large amount of REFe₂ phase was formed, due to the relatively high content of REFe₂ phase was widely distributed among the main phase grains, there was no space for the rare earth elements in the REFe₂ phase to diffuse and they cannot diffuse to the adjacent RE-rich phase to form RE-rich phase with higher rare earth content. Therefore, no sandwich grain boundary structure was formed, and the coercivity was significantly reduced.

The above contents are merely preferred examples of the present disclosure and are not intended to limit thereto. Any modifications, equivalent substitutions, and improvements, etc. made within the spirit and principles of the present disclosure should be included in the scope of protection of the present disclosure.

What is claimed is:

1. A cerium-added RE-T-B-M series sintered neodymium-iron-boron magnet, wherein the structure of the magnet comprises a sandwich grain boundary phase, and the sandwich grain boundary phase comprises a RE-rich phase, a Fe-rich phase, and a REFe₂ phase, wherein in the sandwich grain boundary phase, starting from the side near the grains of RE₂Fe₁₄B main phase, the first layer is the RE-rich phase, the second layer is the Fe-rich phase, and the third layer is the REFe₂ phase, where RE comprises cerium element and at least one of other rare earth elements, and the cerium element accounts for 3.0-15.0% by mass of the total elements, T is iron element and cobalt element, B is boron element, and M is Al, Cu, Ga, and Ti elements.

2. The cerium-added RE-T-B-M series sintered neodymium-iron-boron magnet according to claim 1, wherein in the RE-rich phase of the sandwich grain boundary phase, the element RE atoms account for 50.2% to 62.3%, element T atoms account for 32.2% to 39.7%, and element M atoms account for 2.2% to 10.1%.

3. The cerium-added RE-T-B-M series sintered neodymium-iron-boron magnet according to claim 1, wherein in the Fe-rich phase of the sandwich grain boundary phase, the element RE atoms account for 12.4% to 26.0%, element T atoms account for 68.1% to 81.4%, and element M atoms account for 1.3% to 6.2%.

4. The cerium-added RE-T-B-M series sintered neodymium-iron-boron magnet according to claim 1, wherein in the REFe₂ phase of the sandwich grain boundary phase, the element RE atoms account for 28.1% to 33.8%, element T atoms account for 61.4% to 69.8%, and element M atoms account for 0.6% to 4.8%.

5. The cerium-added RE-T-B-M series sintered neodymium-iron-boron magnet according to claim 1, wherein in the sandwich grain boundary phase, the thickness of the RE-rich phase is 1 nm to 21 nm, the thickness of the Fe-rich phase is 1 nm to 15 nm, and the thickness of the REFe₂ phase is 8 nm to 550 nm.

6. The cerium-added RE-T-B-M series sintered neodymium-iron-boron magnet according to claim 1, wherein the structure of the magnet also comprises a RE₂Fe₁₄B main phase, a RE-rich phase, and a REFe₂ phase, the structure of the magnet comprises RE, boron, aluminum, cobalt, copper, gallium, titanium, iron elements and impurities, the content of each element relative to the total mass is respectively as follows: 30.10 wt. % to 33.50 wt. % of RE element, 0.85 wt. % to 1.05 wt. % of boron element, 0.05 wt. % to 0.60 wt. % of aluminum element, 0.50 wt. % to 2.00 wt. % of cobalt element, 0.10 wt. % to 0.50 wt. % of copper element, 0.10 wt. % to 0.50 wt. % of gallium element, 0.10 wt. % to 0.40 wt. % of titanium element, with the balance of iron element and impurities.
